(19) United States
(12) Patent Application Publication
(10) Pub. No.: US 2017/0216126 A1
(43) Pub. Date: Aug. 3, 2017

(54) Apparatus For Training Dynamic Balance And Turning Manoeuvres During Walking

(71) Applicant: Univerzitetni Rehabilitzcijski Institut Republike Slovenije, Ljubljana (SI)

(72) Inventors: Zlatko Matjacic, Ljubljana (SL); Andrej Olensek, Dobrna (SI)

(21) Appl. No.: 14/718,341

(22) Filed: May 21, 2015

Related U.S. Application Data
(63) Continuation of application No. PCT/SI2013/000073, filed on Nov. 21, 2013.

(30) Foreign Application Priority Data
Nov. 21, 2012 (SI) P-201200354
May 30, 2013 (SI) P-201300140

(51) Int. Cl. A61H 3/00; A61H 3/04; A63B 21/00; A63B 22/14; A63B 22/02; A63B 26/00

(52) U.S. Cl. CPC A61H 3/008; A63B 22/02; A63B 26/003; A63B 21/4009; A63B 22/14; A61H 3/04; A63B 2022/0092

(57) ABSTRACT

The object of the invention is an apparatus suited for individuals in training dynamic balance and turning manoeuvres while walking, said apparatus allowing said operation while an individual is standing, walking on a flat surface or walking on a treadmill that can rotate around its vertical axis. To serve this purpose, the apparatus of the invention is provided with a base platform (1), in which two universal joints (2, 2) are arranged that are connected with a pelvis element (5) with two vertical rods (3,3′) or vertically adjustable rods (30,30′) via conventional spherical joints (4,4′), and the universal joints (2,2′) have two degrees of freedom that can further be provided by drives (6,7,8).

The object of the invention is an apparatus for training dynamic balance and turning manoeuvres during walking. The apparatus of the invention is suited for individuals in training dynamic balance and various turning manoeuvres while standing, while walking on a flat surface or while walking on a treadmill that can rotate around its vertical axis. The invention belongs to class A 63B 26/00 of the European Patent Classification.

The technical problem successfully solved by the apparatus of the present invention is to provide such an aid that would allow suitable and especially safe dynamic balance training and consequently coordinated motion of the entire body especially of elderly and disabled individuals.

A variety of neurological disorders, as well as aging, result in a reduced ability to walk, which increases the odds of the disabled and also elderly population to fall. Apart from reduced muscular strength, inadequate sensory-motor coordination of motion and reduced abilities to turn or manoeuvre pose the main obstacle to functional walking. The mentioned abilities need to be maintained or re-trained, wherein it is important that training is done in a safe way and should include dynamic balance training. An important part of functional abilities to walk comprises manoeuvres such as initiation and acceleration, stopping and deceleration, changing direction while walking and turning, turning on the spot and backward walking. Currently, there are numerous electromechanical devices (e. g. LOKOMAT, Gait Trainer) that support walking either on a treadmill or on the floor and simultaneously offer a partial weight relief; however, said devices only provide for walking in one direction and what's more important the mobility of the pelvis and the body is considerably limited.

An apparatus, in which the movement of the pelvis is provided for in directions left/right and forward/backwards while an individual is standing is disclosed in U.S. Pat. No. 7,086,996. The main constructional feature of said apparatus resides in two mechanical assemblies comprising a vertical spring, the effective length of which can be changed in a simple way thus setting the extent of a mechanical bracing of the pelvis belt. The apparatus has two degrees of freedom: it provides for a body inclination while standing on the spot forward and backwards and left and right. It does not provide for rotation of the body around a vertical axis, which is of key importance when changing a walking direction.

The described prior art does not disclose an apparatus that would allow dynamic balance training in conditions, in which the pelvis and the body are adequately supported and yet coordinated motion of the entire body could be trained, which is needed in performing the above-mentioned manoeuvres. The described training is currently only possible by assistance of at least two physiotherapists.

The apparatus of the invention consists of a parallel mechanism, where universal joints are arranged in a base platform, said joints being connected via conventional spherical joints with a pelvis element in the first embodiment with two vertical rods and in the second embodiment with two vertical telescopic rods, said universal joints having two degrees of freedom that may be provided with a drive.

The invention will be described in more detail by way of an embodiment and figures, in which:

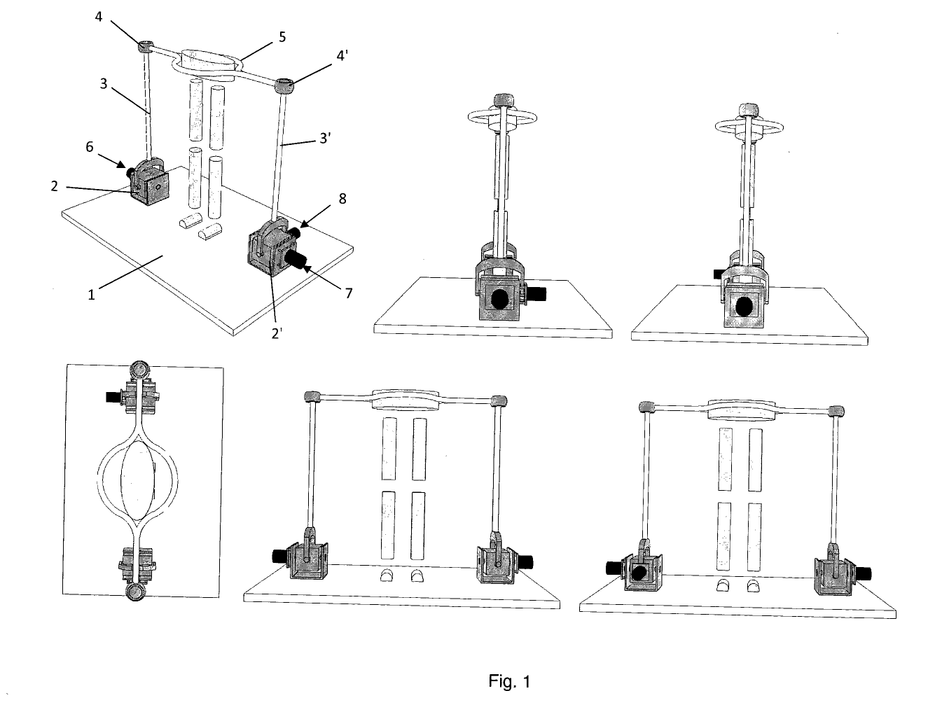

FIG. 1 shows a schematic demonstration of the apparatus of the invention and the first embodiment;

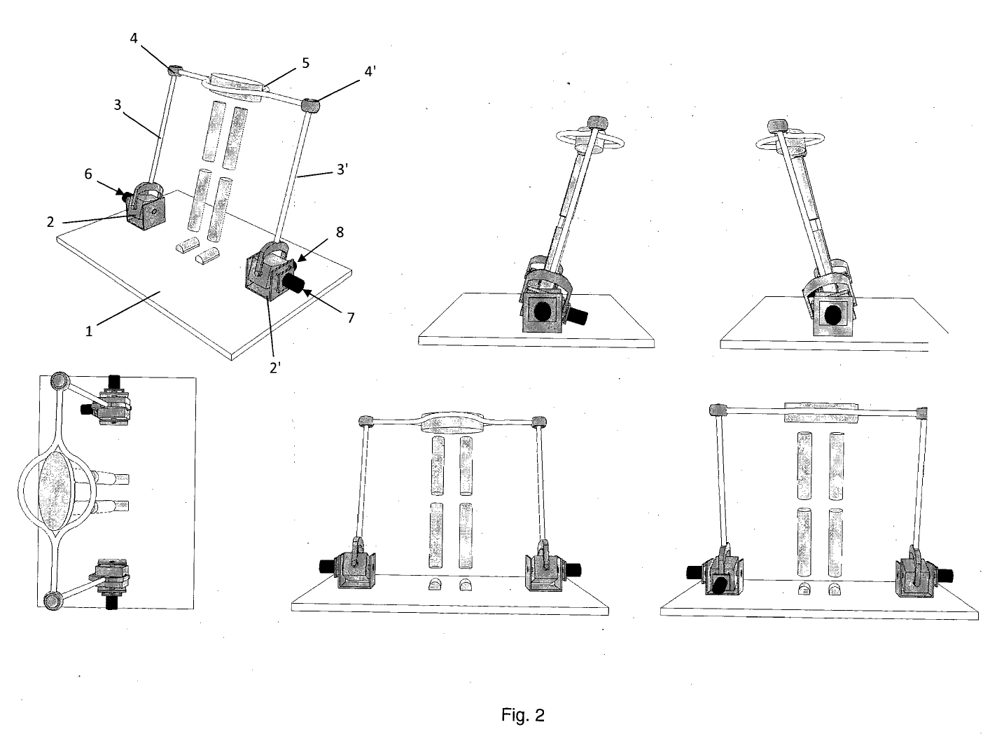

FIG. 2 shows a schematic demonstration of backward motion of a standing subject in the apparatus of the invention according to the first embodiment;

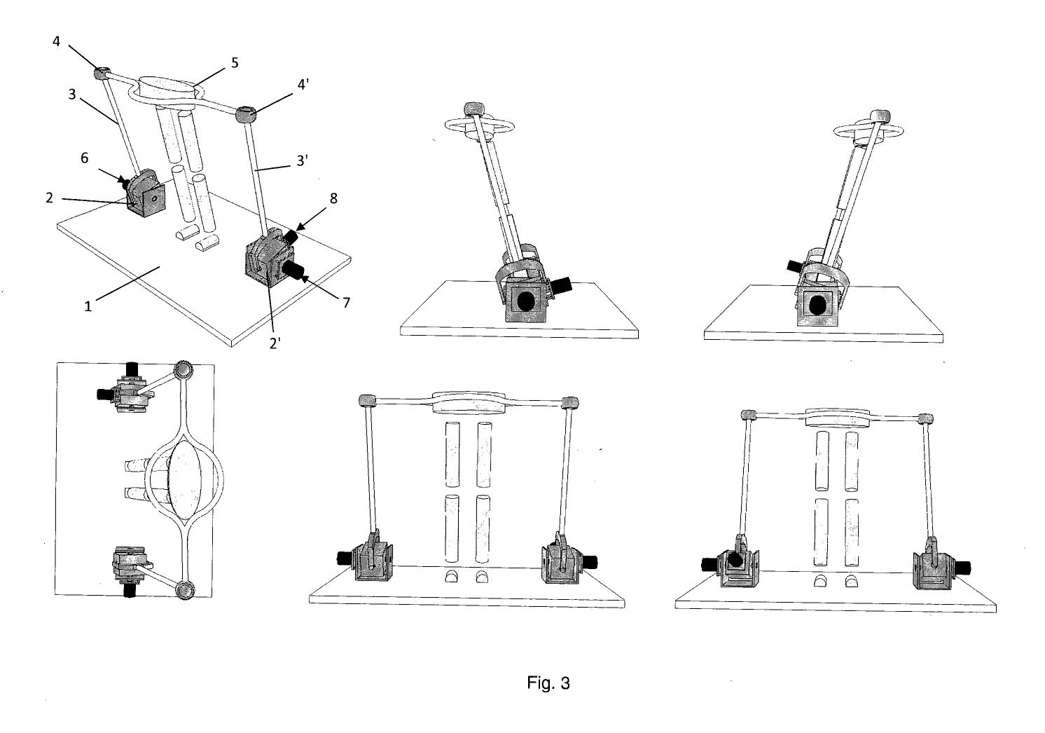

FIG. 3 shows a schematic demonstration of forward motion of a standing subject in the apparatus of the invention according to the first embodiment;

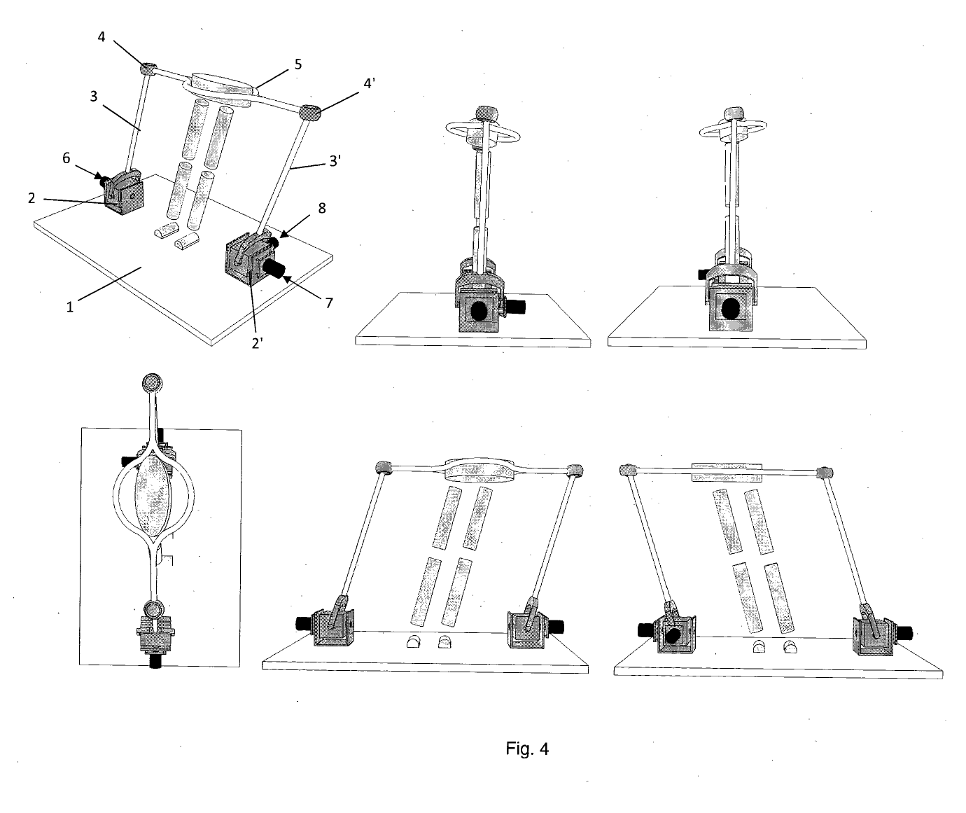

FIG. 4 shows a schematic demonstration of motion of a standing subject to the left in the apparatus of the invention according to the first embodiment;

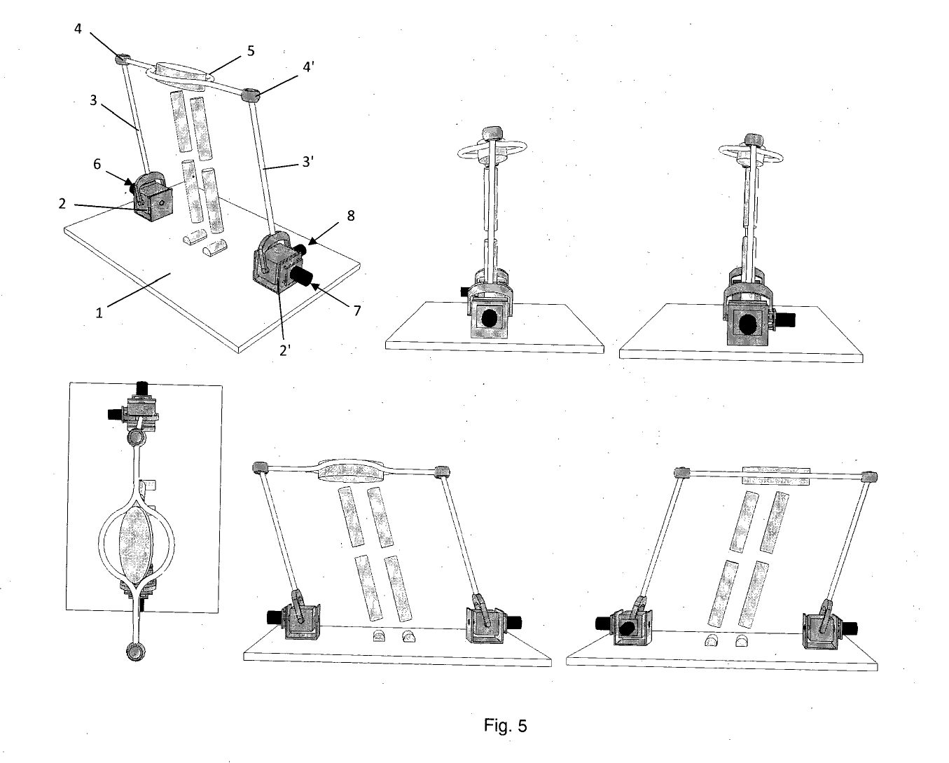

FIG. 5 shows a schematic demonstration of motion of a standing subject to the right in the apparatus of the invention according to the first embodiment;

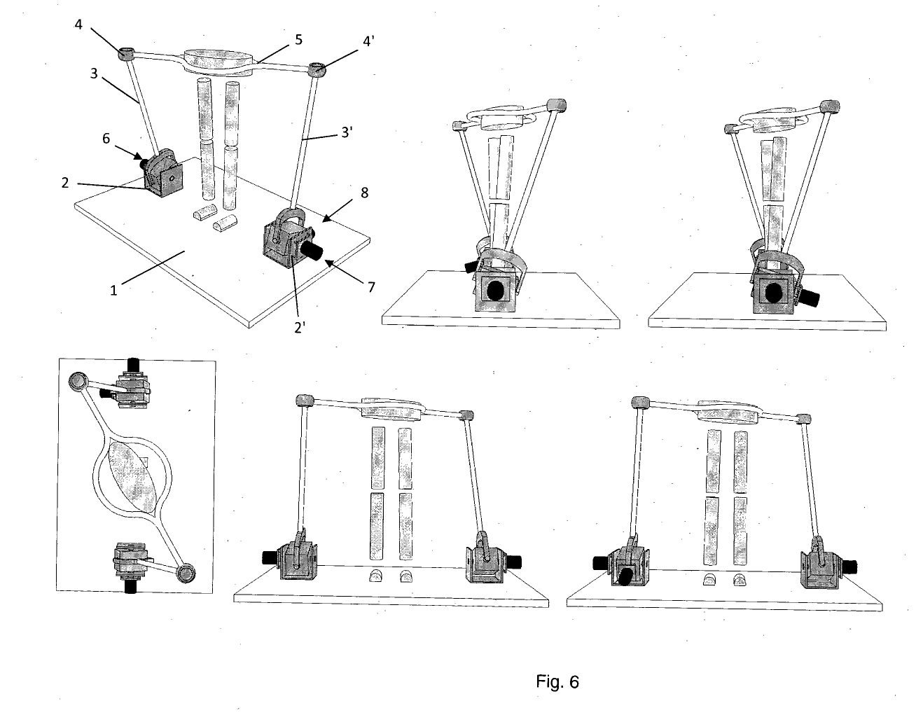

FIG. 6 shows a schematic demonstration of a standing subject rotating to the left around a vertical axis in a transversal plane in the apparatus of the invention according to the first embodiment;

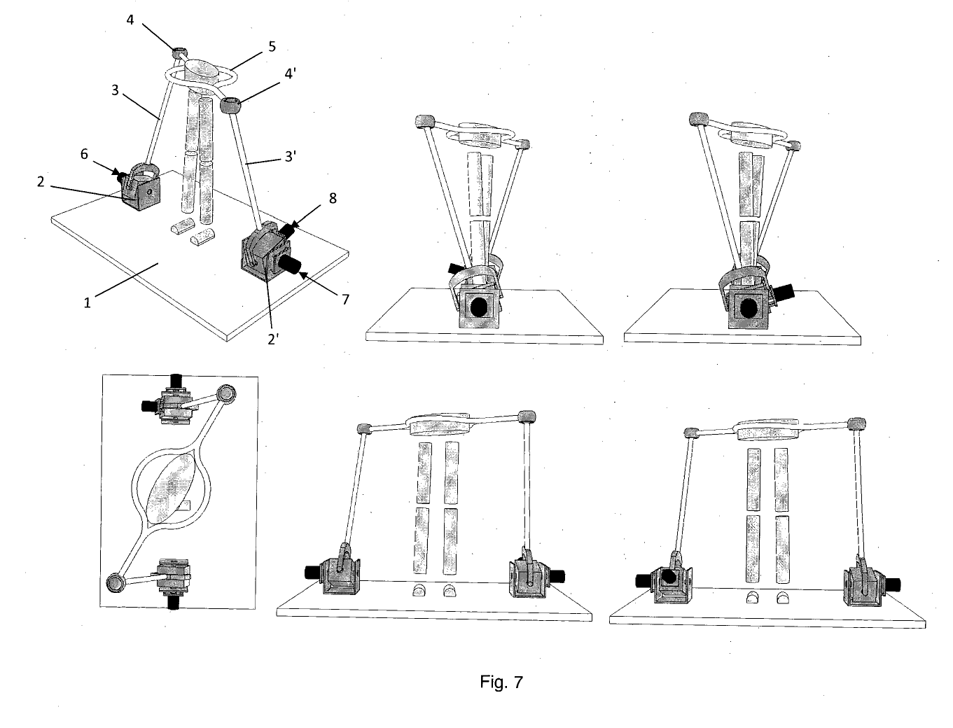

FIG. 7 shows a schematic demonstration of a standing subject rotating to the right around a vertical axis in a transversal plane in the apparatus of the invention according to the first embodiment;

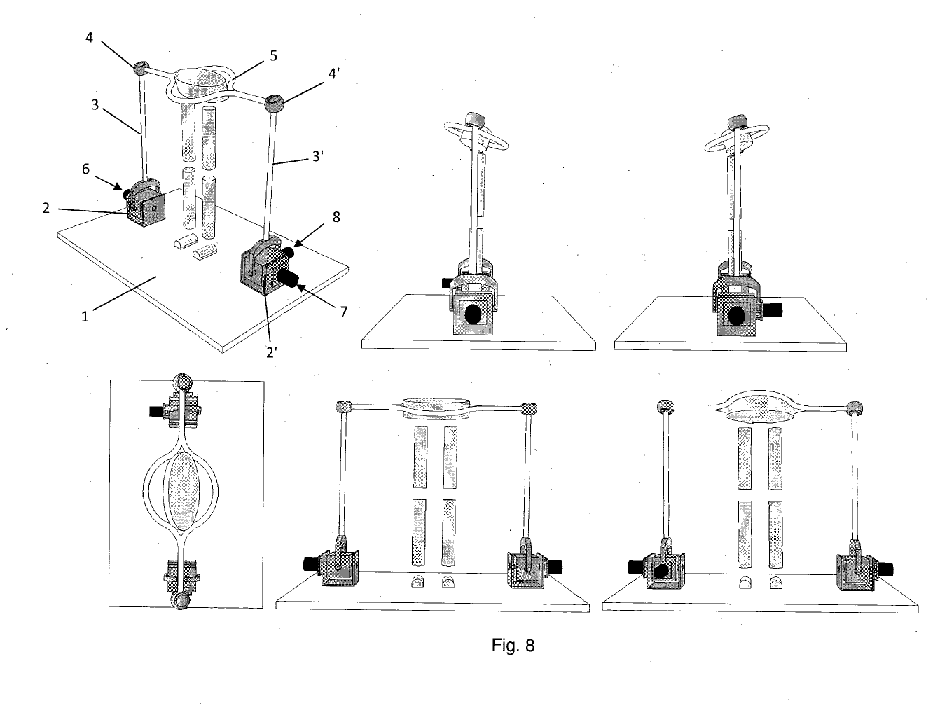

FIG. 8 shows a schematic demonstration of a passive tilt of the pelvis of a standing subject forward in the apparatus of the invention according to the first embodiment;

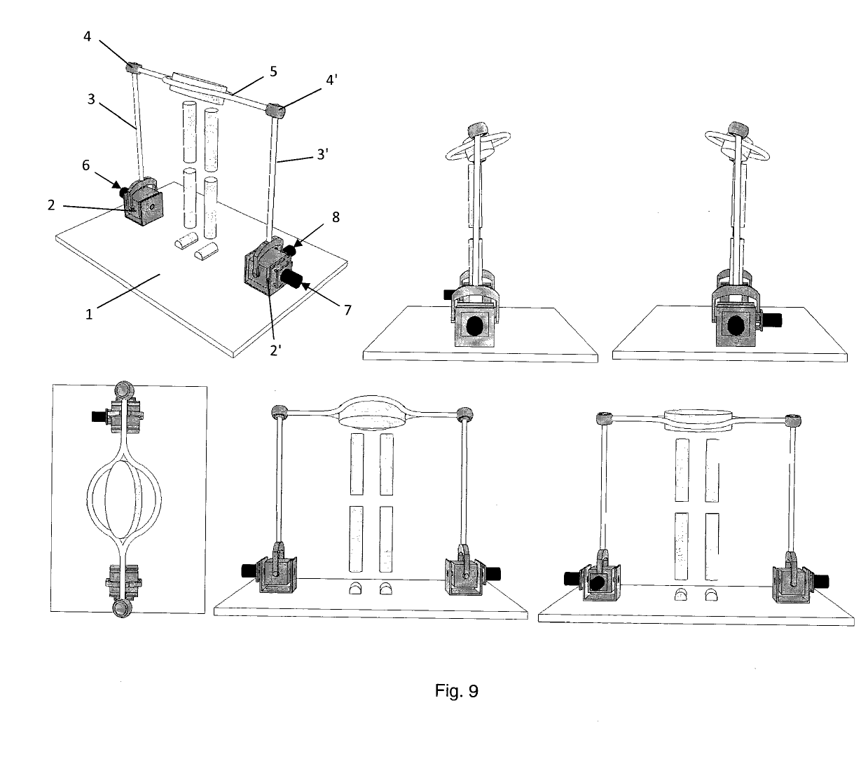

FIG. 9 shows a schematic demonstration of a passive tilt of the pelvis of a standing subject backwards in the apparatus of the invention according to the first embodiment;

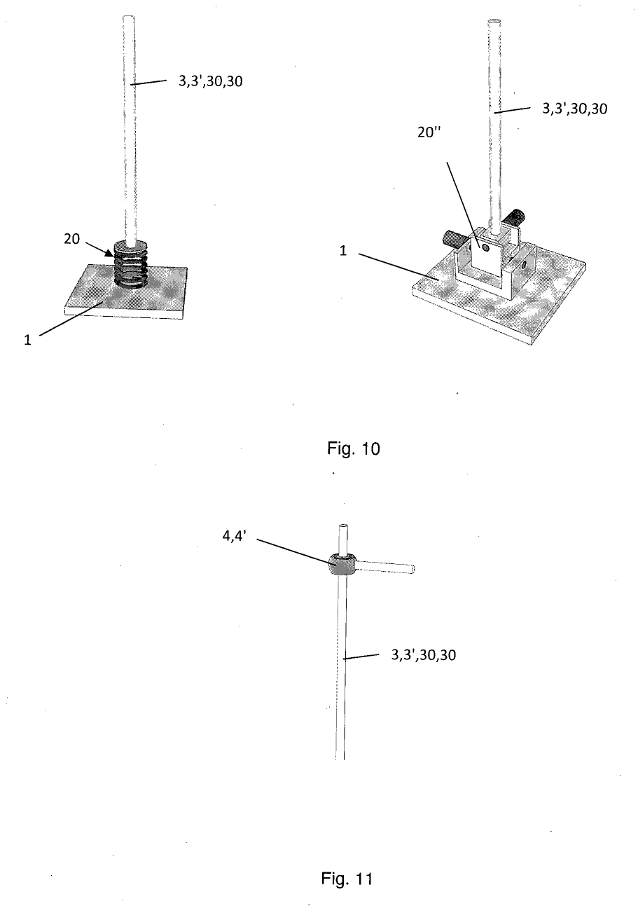

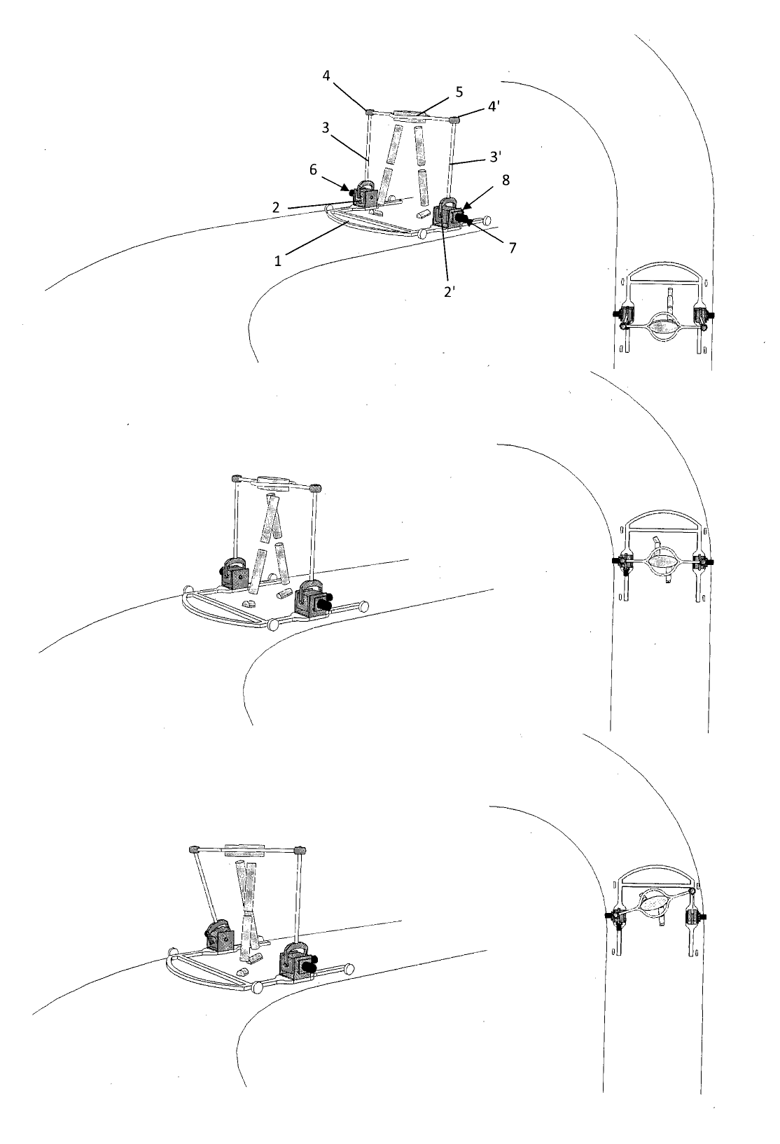

FIG. 10 shows a schematic demonstration of possible variants of universal joints of the invention;

FIG. 11 shows a detail of an alternative connection of the vertical rod with the spherical joint;

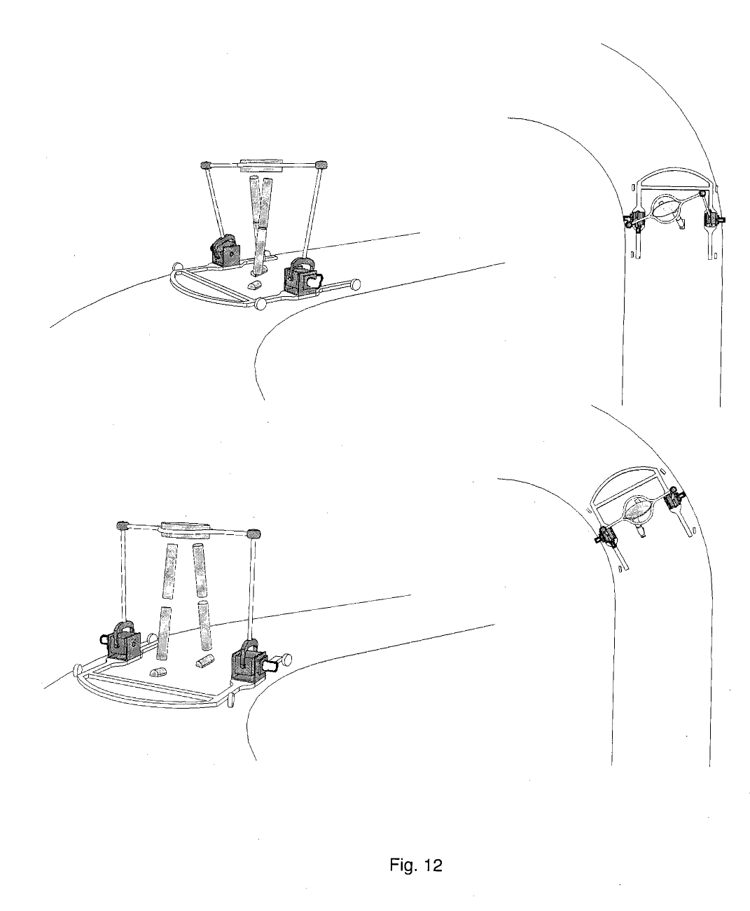

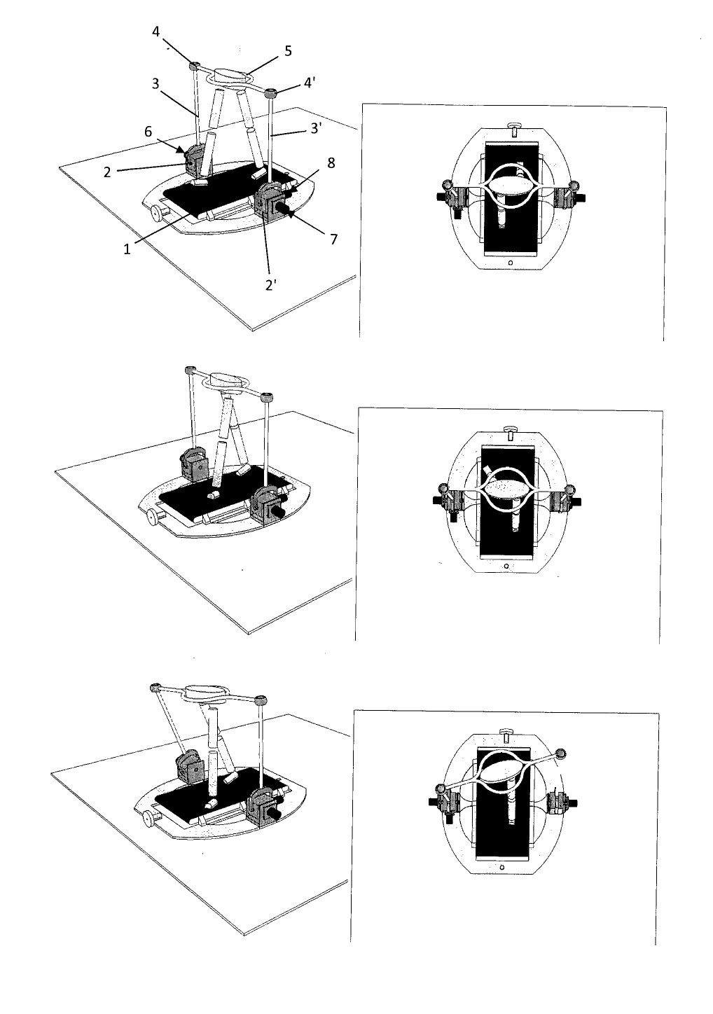

FIG. 12 shows a schematic demonstration of motion of a subject with the apparatus of the invention, where the base platform is a motorised mobile platform according to the first embodiment;

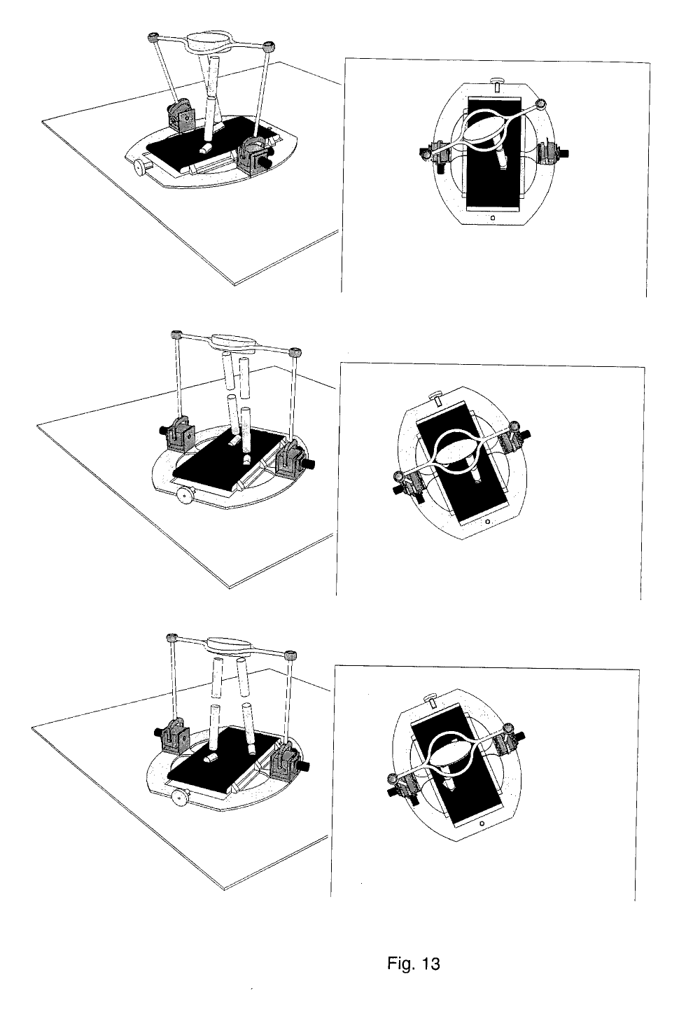

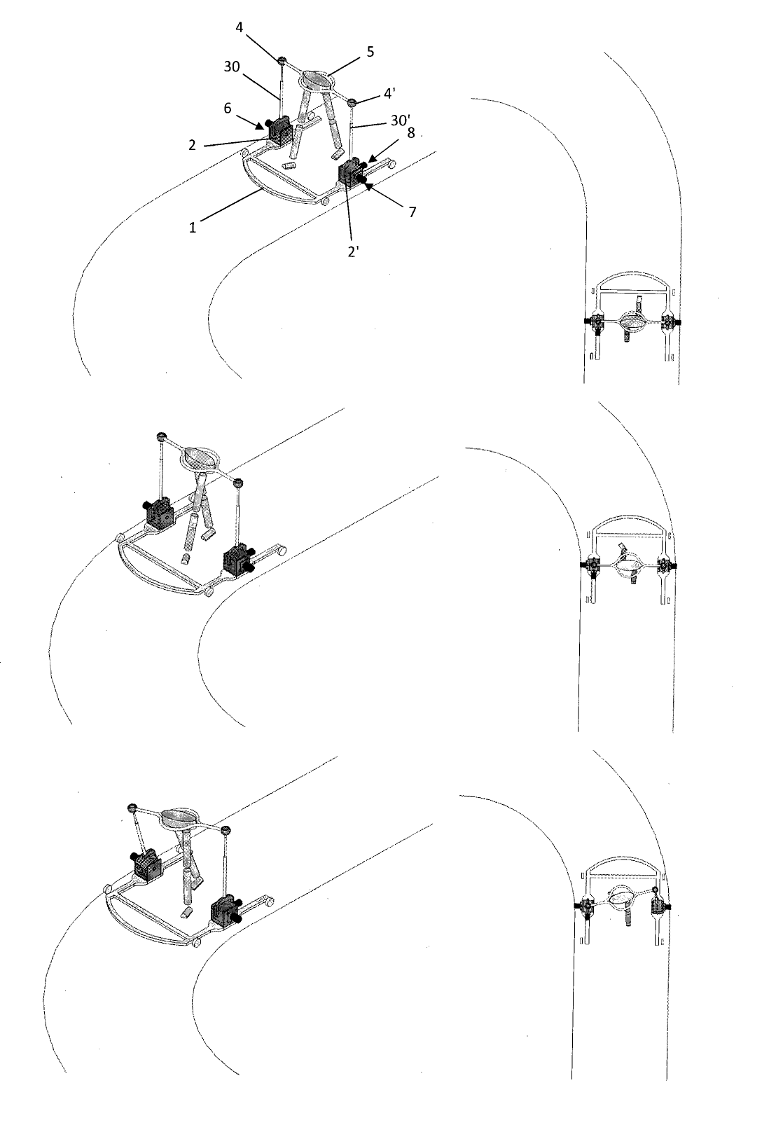

FIG. 13 shows a schematic demonstration of motion of a subject with the apparatus of the invention, where the base platform is a motorised platform with a treadmill according to the first embodiment;

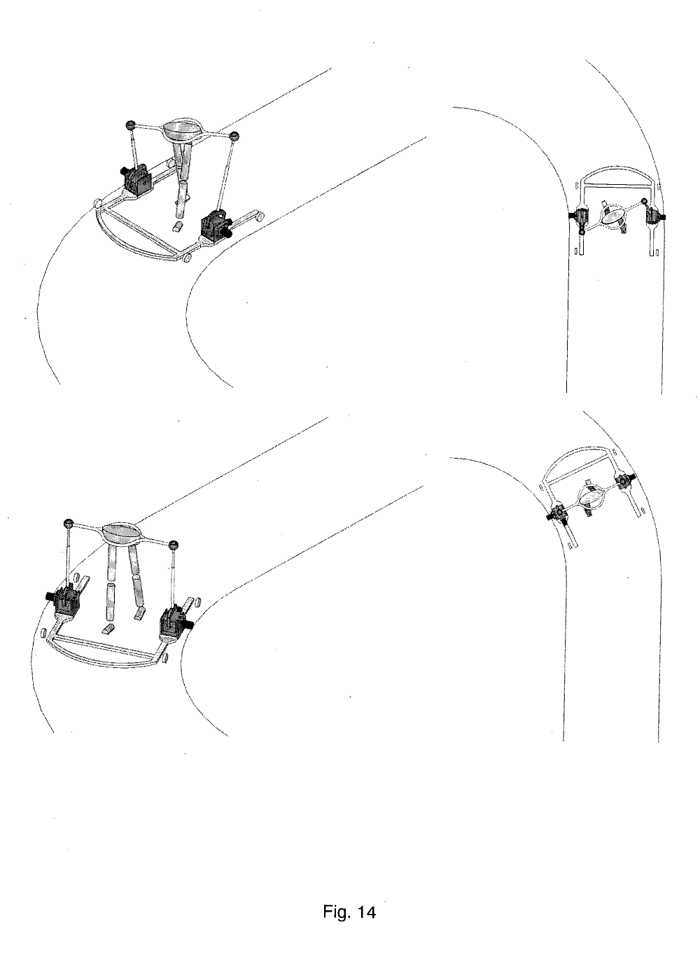

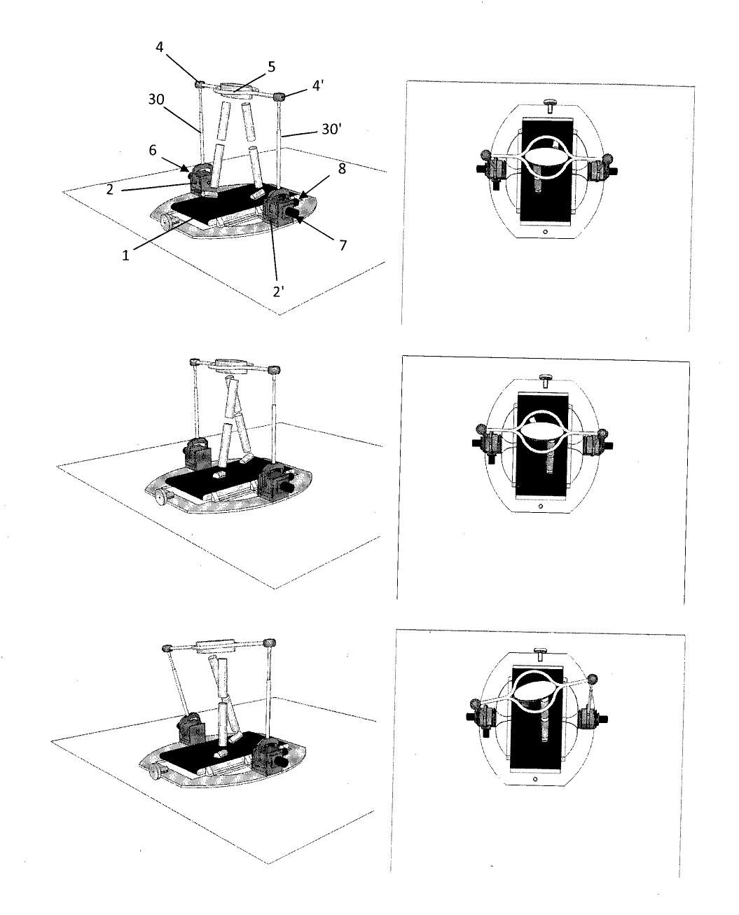

FIG. 14 shows a schematic demonstration of motion of a subject with the apparatus of the invention, where the base platform is a motorised mobile platform according to the second embodiment;

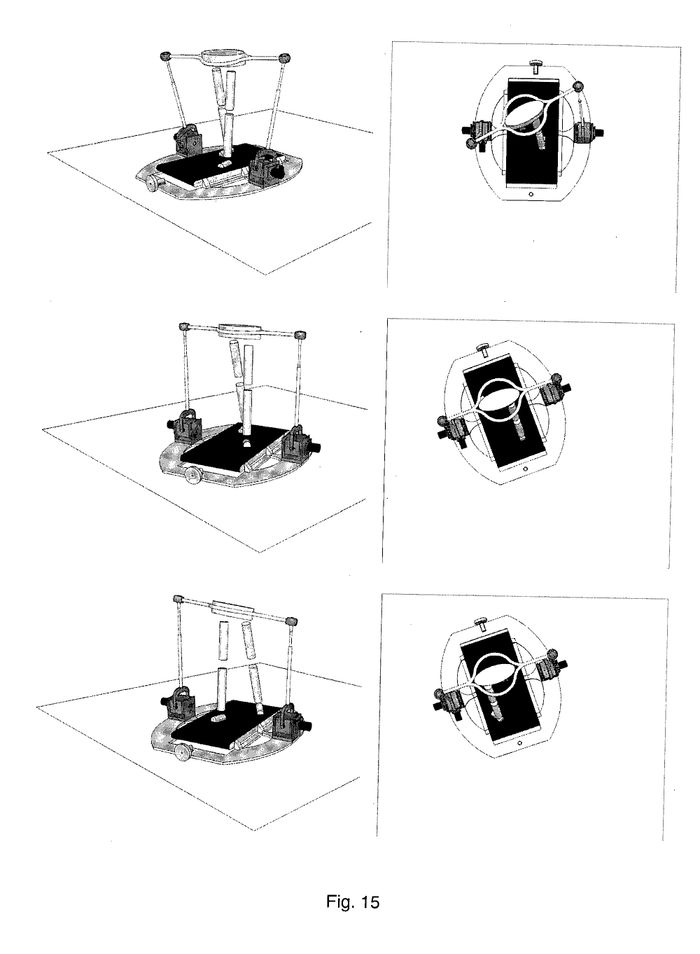

FIG. 15 shows a schematic demonstration of motion of a subject with the apparatus of the invention, where the base platform is a motorised platform with a treadmill according to the second embodiment.

FIG. 1 is a schematic demonstration of a lower body part of a standing subject who is supported in the pelvis area by the apparatus of the invention according to the first embodiment; the apparatus allows training of dynamic balance and turning manoeuvres. The apparatus of the invention is represented by a parallel mechanism comprising: a base platform 1, on which universal joints 2,2′ are arranged, said joints being connected with a pelvis element 5 by two vertical rods 3,3′ via conventional spherical joints 4,4′.

Each universal joint 2,2 has two degrees of freedom, wherein one degree of freedom of the universal joint 2 is provided with a drive 6, whereas both degrees of freedom of the universal joint 2′ are provided with drives 7,8.

The drives 6,7,8 are active servo drives, but can also be replaced by passive viscoelastic elements with variable impedance features.

The base platform 1 can be a simple panel, a motorised mobile platform or a motorised platform with a treadmill arranged, wherein the motorised platform can rotate around the vertical axis as will be described hereinbelow.

The apparatus for training dynamic balance and turning manoeuvres during walking according to the first embodiment of the invention has a total of four degrees of freedom with respect to the described components. Three degrees of freedom are motorised (provided with a drive) and one is passive as shown in FIGS. 2 to 9.

FIGS. 2 and 3 show inclination of the standing subject forward and backwards in a sagittal plane. Inclination forward and backwards can be assisted or guided (in terms of either positional servo guiding or impedance guiding) by the motor drives 6 and 7. FIGS. 4 and 5 show inclination of a standing subject to the left and right in a frontal plane. Inclination to the left and right is assisted or guided (in terms of either positional servo guiding or impedance guiding) by the drive 8.

FIGS. 6 and 7 show a key degree of freedom of the proposed apparatus of the invention, namely rotation of the pelvis of a standing subject around a vertical axis in the transversal plane in clockwise direction as well as in counterclockwise direction. The described rotation of the standing subject's pelvis can be assisted or guided (in terms of either positional servo guiding or impedance guiding) by adequate operation of the drives 6 and 7. Motion in all three described degrees of freedom (inclination forward/backwards, inclination left/right and rotation in transversal plane) can be simultaneous and can be adequately assisted by adequate operation of the drives 6, 7 and 8.

FIGS. 8 and 9 show a fourth degree of freedom of the proposed apparatus, i. e. passive tilt of the standing subject's pelvis forward and backwards in the sagittal plane. This degree of freedom is controlled by the standing subject.

All FIGS. 1 to 9 illustrate the use and functioning of the apparatus of the invention for the purposes of training of dynamic balance and rotation of the body around the vertical axis during standing.

Possible concrete variants of the universal joint 2,2′ which in principle do not change the number of degrees of freedom and the described functionality of the entire apparatus of the invention and do not limit the present invention in any way whatsoever are shown in FIG. 10. Practical implementation of such a joint may be complicated as it requires precise manufacturing and fixation of both axes.

In a first constructional variant each universal joint 2,2′ can be replaced by a vertical spring 20, one end of which is fastened to the base platform 1 and the other end is fastened to a vertical rod 3,3′,30,30′. In this case, the entire mechanism is passive and exhibits mechanical impedance which is exerted on an individual's pelvis in the form of viscoelastic forces.

According to a second constructional variant each universal joint 2,2′ can be replaced by two simple rotational joints 20′,20″ each having only one axis of rotation, and the first simple joint 20′ is fixed to the base platform 1, whereas the second simple joint 20″ is fixed to the axis of the first simple joint 20′ in a way that the axes of rotation of both simple joints 20′, 20″ are perpendicular, yet do not intersect at the same point.

In the apparatus of the invention and the second embodiment the vertical rods 3,3′ which have a defined, unadjustable length can be replaced by vertically adjustable rods 30,30′ which can contain a translational joint that allows length adjustment of the rods 30,30′ and each of them can be embodied as a telescopic assembly of two rods and also balanced, for instance with a spring or a similar constructional element that compensates for the weight of the pelvis element 5. A further adjustment option is also possible by a constructional variant where the upper end of the rods 3,3′,30,30′ is slidably through-connected with the spherical joints 4,4′, which is shown in FIG. 11.

By the replacement of the vertical rods 3,3′ with the vertically adjustable telescopic rods 30,30′ the apparatus of the invention in the second embodiment thus provides for two new degrees of freedom: bias of the pelvis downwards/upwards in the frontal plane and a vertical shift of the pelvis downwards/upwards in all variants shown in FIGS. 1 to 9; a possibility of use of the vertically adjustable telescopic rods 30,30′ is specifically shown in FIGS. 14 and 15.

In case when the base platform 1 is a motorised mobile platform, it allows training of dynamic balance and turning manoeuvres during walking on the ground. A sequence of images in FIG. 12 first shows walking in one direction, then follows a curve needed for an adequate change of direction during walking, which can be achieved in two ways. In the first way, the walking subject initiates a manoeuvre of turning to a new direction by adequately rotating the pelvis, which is followed by an adequate rotation of the mobile platform and the adequate movement of the apparatus. In the second way, the apparatus initiates rotation of the pelvis, which is followed by an adequate rotation of the mobile platform. In both ways the walking subject has a possibility of training of dynamic balance and turning manoeuvres assisted by motorised degrees of freedom that suit his/her current abilities.

In case when the base platform 1 is a motorised platform with a treadmill that can rotate around the vertical axis, it allows training of dynamic balance and turning manoeuvres during walking on the treadmill. A sequence of images in FIG. 13 shows a turning manoeuvre that is principally identical to the turning manoeuvre shown in FIG. 12, a difference being in that here the mobile platform cannot freely move in a space but is limited to the rotation about the fixed axis of rotation.

In case when the base platform 1 is a motorised mobile platform according to the second embodiment shown in FIG. 14, it allows in addition to the already disclosed possibilities of manoeuvring with the apparatus of the invention according to the first embodiment, as described and shown in FIG. 13, also rotating of the pelvis upwards/downwards in the frontal plane and the vertical shift of the pelvis upwards/downwards.

In case when the base platform 1 is a motorised platform with a treadmill according to the second embodiment of FIG. 15 that can rotate around the vertical axis, it allows training of dynamic balance and turning manoeuvres during walking on the treadmill. A sequence of images in FIG. 15 shows a turning manoeuvre that is principally identical to the turning manoeuvre shown in FIG. 14, a difference being in that the mobile platform in this case is not limited only to rotation around the fixed axis of rotation but the axis of rotation can be anywhere, also for instance in the centre of the conveyor belt.

The inventive aspect of the proposed apparatus for training of dynamic balance and turning manoeuvres during walking of the invention resides especially in a unique kinematic structure that enables the subject to train dynamic balance and rotation around the vertical body axis by a simultaneous motion of the lower body segments in the sagittal and frontal planes while standing, walking on the ground and walking on the treadmill that can rotate around the vertical axis. The motion of the proposed apparatus of the invention is from the biomechanical and physiological aspects in consistence with the motion of a human locomotor apparatus.

1. An apparatus for training dynamic balance and turning manoeuvres during walking
characterized in that
on a base platform (1) two universal joints (2, 2′) are arranged that are connected with a pelvis element (5) with two vertical rods (3,3′) or vertically adjustable rods (30,30′) via conventional spherical joints (4,4′).

2. Apparatus according to claim 1
characterized in that
each universal joint (2,2′) has two degrees of freedom, wherein one degree of freedom of the universal joint (2) is provided with a drive (6), whereas both degrees of freedom of the universal joint (2′) are provided with drives (7,8).

3. Apparatus according to claim 2
characterized in that
each universal joint (2,2′) can be replaced by a vertical spring (20) or by two simple rotational joints (20′, 20″) each having only one axis of rotation and the first simple joint (20′) being fastened to the base platform (1) and the second simple joint (20″) being fastened to the axis of the first simple joint (20′) in a way that the axes of rotation of both simple joints (20′, 20″) are perpendicular, yet do not intersect at the same point.

4. Apparatus according to claim 2
characterized in that
the drives (6,7,8) are active servo drives or passive viscoelastic elements with variable impedance features.

5. Apparatus according to claim 1
characterized in that
the base platform (1) can be a simple panel, a motorised mobile platform or a motorised platform with a treadmill arranged that can rotate around the vertical axis.
